(19) United States
(12) Patent Application Publication
(10) Pub. No.: US 2026/0277315 A1
(43) Pub. Date: Sep. 17, 2026

(54) VIDEO DISPLAY SYSTEM, VIDEO DISPLAY METHOD, AND PORTABLE INFORMATION TERMINAL

(71) Applicant: MAXELL, LTD., Kyoto (JP)

(72) Inventors: Sadao TSURUGA, Kyoto (JP); Yasunobu HASHIMOTO, Kyoto (JP); Junji SHIOKAWA, Kyoto (JP)

(21) Appl. No.: 19/168,945

(22) PCT Filed: Apr. 4, 2023
(86) PCT No.: PCT/JP2023/013959

§ 371 Date: Sep. 25, 2025

(51) Int. Cl. G06F 3/01; G06T 19/00; H04L 65/70; H04R 5/033; H04S 7/00

(52) U.S. Cl. CPC G06F 3/013; G06T 19/00; H04L 65/70; H04R 5/033; H04S 7/304; G06T 2219/024; H04S 2400/11

(57) ABSTRACT

In a video display system including a server and a plurality of video display devices, which are connected for communication therebetween, the server stores therein participant management information in which avatars corresponding to users of the video display devices, respectively, is recorded, and transmits the participant management information to the video display devices, respectively. Each of the video display devices accepts selection of a virtual reality space to be used for the video display device, refers to the participant management information to generate a video in which avatars corresponding to all other users than a user of the video display device are placed in the virtual reality space of which selection has been accepted by the video display device, and displays the video.

### TECHNICAL FIELD

The present invention relates to a video display system, a video display method, and a portable information terminal, and in particular, relates to a technique for displaying a video in which an avatar is placed on a virtual reality space.

### BACKGROUND ART

In recent years, various information terminals including PCs have become available in the market. Among them, in head-mounted display devices (hereinafter, referred to as an “HMD”), which are portable video display devices, the ones configured to superimpose a three-dimensional image of augmented reality (AR) and display it by a computer in the form of glasses, and the ones called as immersive HMDs, which cover the entire eyes and are configured to display a three-dimensional image of virtual reality (VR) on a display screen thereof have been known.

For such HMDs, for example, application software allowing a remote meeting involving multiple participants to be held in a virtual meeting room through a network, even though all the participants are in different locations, and also allowing a user's own representation (avatar) and representations (avatars) of other users to be displayed on the display screen have been available.

As a prior art in this technical field, Patent Literature 1 discloses the following (excerpted from abstract): “Based on three-dimensional space data about a virtual reality space, avatar data about avatars that are representations of a plurality of viewers who are present in the real space, and relative position data indicating the real relative positional relationships among the plurality of viewers, a virtual reality space image in which the user's own position is set as a predetermined position on the screen, and, using this predetermined position as a reference, avatar images are placed at positions reflecting the real relative positional relationships among the plurality of viewers is displayed. This allows the virtual reality space image displayed on each HMD to display the avatar images of other viewers at the same relative positions as those in the real space when viewed from each viewer, so that a more realistic virtual reality space image can be provided”.

### CITATION LIST

### Patent Literature

Patent Literature 1: WO 2018/198777

### SUMMARY OF INVENTION

### Technical Problem

In the technique according to Patent Literature 1 described above, all meeting participants need to use a shared meeting room predetermined by the system. In other words, the technique according to Patent Literature 1 has a system constraint that does not allow meeting participants to freely choose a meeting room.

The object of the present invention is to provide a video display system, a video display method, and a portable information terminal which allow, in a conversation by multiple users in a remote environment, each user to select a virtual reality space for placing his or her own avatar according to his or her own preference.

### Solution to Problem

In order to solve the problems described above, the present invention includes the technical features recited in the scope of claims. One of the aspects thereof is a video display system comprising: a server; and a plurality of video display devices, the server and the plurality of video display devices being connected for communication therebetween, respectively, the server including: a storage device configured to store participant management information in which avatars corresponding to users of the plurality of video display devices, respectively, is recorded; and a first communication interface configured to transmit the participant management information to the plurality of video display devices, respectively, and each of the video display devices including: a second communication interface configured to receive the participant management information; an operation device configured to receive selection of a virtual reality space to be displayed on the video display device; a display; and a processor configured to refer to the participant management information to generate a video in which avatars corresponding to all other users than a user of the video display device are placed in the virtual reality space selected for the video display device, and carry out display control for the display

### Advantageous Effects of Invention

According to the present invention, it is possible to provide a video display system, a video display method, and a portable information terminal which allow, in a conversation by multiple users in a remote environment, each user to select a virtual reality space for placing his or her own avatar according to his or her own preference.

The problems, configurations, and advantageous effects other than those described above will be clarified by explanation of the embodiments below.

### BRIEF DESCRIPTION OF DRAWINGS

FIG. 1 is a schematic configuration diagram schematically illustrating a configuration of a video display system.

FIG. 2A is a hardware configuration diagram illustrating an example of an internal configuration of an HMD.

FIG. 2B is a hardware configuration diagram illustrating an example of an internal configuration of a server.

FIG. 3 is a flowchart illustrating a processing procedure by an HMD for entry of a virtual meeting room.

FIG. 4 illustrates a virtual meeting room selection screen.

FIG. 5 is a schematic diagram illustrating that placement of avatars An is decided.

FIG. 6 is a schematic diagram illustrating that placement of objects Bk to be placed in a virtual meeting room is decided.

FIG. 7A is a schematic diagram as viewed from above, illustrating a virtual meeting room 301 selected by a participant P1.

FIG. 7B is a schematic diagram as viewed from above, illustrating a virtual meeting room 302 selected by a participant P2.

FIG. 7C is a schematic diagram as viewed from above, illustrating a virtual meeting room 303 selected by a participant P3.

FIG. 8 illustrates a participant management table for use in a remote meeting system.

FIG. 9A is a schematic diagram illustrating the configuration of a virtual meeting room 301.

FIG. 9B is a schematic diagram illustrating the configuration of a virtual meeting room 302.

FIG. 9C is a schematic diagram illustrating the configuration of a virtual meeting room 303.

FIG. 10 is a schematic diagram illustrating an image being displayed on an HMD G1.

FIG. 11A is a schematic diagram illustrating the configuration of a virtual meeting room 301.

FIG. 11B is a schematic diagram illustrating the configuration of a virtual meeting room 302.

FIG. 11C is a schematic diagram illustrating the configuration of a virtual meeting room 303.

FIG. 12 illustrates a management table for a remote meeting system.

FIG. 13A is a schematic diagram illustrating the configuration of a virtual meeting room 301.

FIG. 13B is a schematic diagram illustrating the configuration of a virtual meeting room 302.

FIG. 13C is a schematic diagram illustrating the configuration of a virtual meeting room 303.

FIG. 14 illustrates a participant management table for the situation illustrated in FIG. 13.

FIG. 15A is a schematic diagram illustrating the configuration of a virtual meeting room 301.

FIG. 15B is a schematic diagram illustrating the configuration of a virtual meeting room 302.

FIG. 15C is a schematic diagram illustrating the configuration of a virtual meeting room 303.

FIG. 16 illustrates a participant management table for the situation illustrated in FIG. 15.

FIG. 17 illustrates that a participant is wearing stereo headphones.

FIG. 18 is a schematic diagram illustrating placement of each avatar in a virtual meeting room.

FIG. 19 illustrates a participant management table according to the third embodiment.

FIG. 20A is a schematic diagram illustrating that virtual meeting rooms of other participants, for which copying is permitted, are displayed in parallel.

FIG. 20B is a schematic diagram illustrating a display example of selection of a virtual meeting room.

FIG. 21 is a flowchart illustrating a processing flow according to the third embodiment.

FIG. 22 illustrates a program configuration example according to the present embodiment.

### DESCRIPTION OF EMBODIMENTS

Hereinafter, embodiments of the present invention will be described in detail with reference to the drawings. Throughout all the drawings, members having the same function are provided with the same reference signs, and repeated explanations thereof will be omitted.

The virtual reality display technology according to the present invention enables new forms of communication through virtual reality display, and therefore, is expected to contribute to the United Nations Sustainable Development Goals (SDGs), specifically “9. Build resilient infrastructure, promote inclusive and sustainable industrialization and foster innovation”.

### First Embodiment

In the first embodiment, each of a plurality of video display devices is connected for communication to a remote meeting distribution server, and each participant selects his or her preferred virtual meeting room and sets the layout to conduct a remote meeting with other participants. One of the advantageous features of the present embodiment is that, even if the virtual meeting room selected by one participant is different from that selected by other participants, the avatars of all the other participants participating in the same remote meeting are displayed.

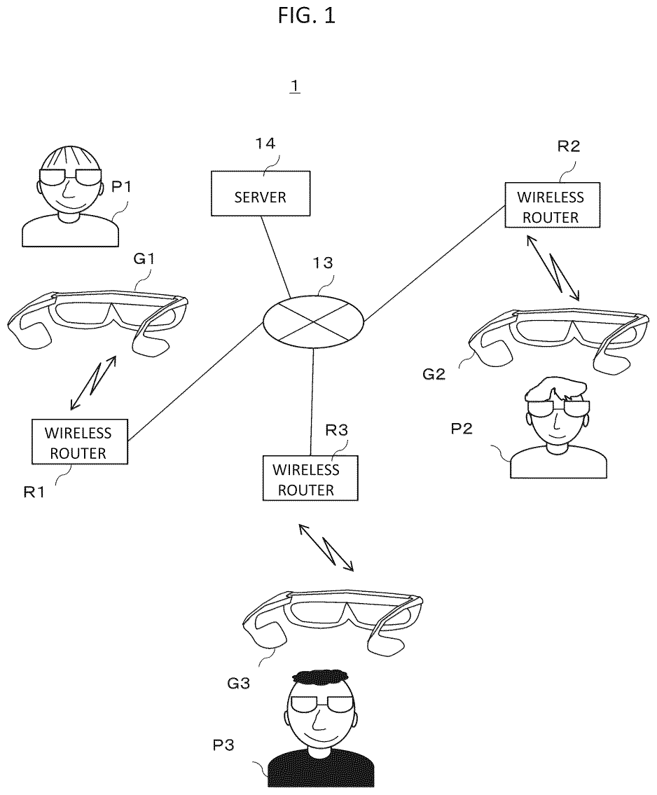

FIG. 1 is a schematic configuration diagram schematically illustrating the configuration of the video display system. In FIG. 1, the video display system 1 is used for a remote meeting held in virtual meeting rooms. In FIG. 1, the explanation is given assuming that three participants (a first participant P1, a second participant P2, and a third participant P3) are participating in the remote meeting, but the number of participants is not limited to three.

In FIG. 1, the first participant P1 wearing an HMD G1 (head-mounted display), which is the first video display device, the second participant P2 wearing an HMD G2, and the third participant P3 wearing the HMD G3 are connected to a network 13 via a wireless router R1, a wireless router R2, and a wireless router R3, respectively. A server 14 is also connected to the network 13. Although just the one server 14 is illustrated in FIG. 1, the functions of the server 14 may be divided and implemented by a plurality of servers.

The server 14 distributes, over the network 13, various types of virtual meeting rooms that are pre-registered in this remote meeting system, as well as objects representing items within the virtual meeting rooms which will be described later, whiteboards, image data about each participant's avatar, and the like.

The various types of image data distributed from the server 14 are delivered, via the network 13, to the HMD G1 through the wireless router R1, to the HMD G2 through the wireless router R2, and to the HMD G3 through the wireless router R3, respectively. A video included in the distributed live content is displayed on a display screen of each HMD, and an audio included therein is output from a speaker of each HMD.

Furthermore, the server 14 manages various types of information acquired through the network 13. One type of the information managed by the server 14 is the avatar management information. The avatar management information is the information that associates the virtual reality space identification information, which uniquely identifies the virtual reality space selected by each of the HMD G1, the HMD G2, and the HMD G3, with the avatar identification information that uniquely identifies the avatar of the participant P1, the avatar identification information that uniquely identifies the avatar of the participant P2, and the avatar identification information that uniquely identifies the avatar of the participant P3. In each of the virtual reality spaces associated by the avatar management information, all the avatars indicated by the avatar identification information associated with each of the virtual reality spaces are superimposed and displayed.

Still further, the server 14 stores therein the information about the participants, the action information about the HMD G1 (action information about the first participant P1) and the audio information acquired via the wireless router R1, the action information about the HMD G2 (action information about the second participant P2) and the audio information acquired via the wireless router R2, and the action information about the HMD G3 (action information about the third participant P3) and the audio information acquired via the wireless router R3.

The information about the participants includes the participant information (participant identification information) such as real names, nicknames, or handles, the avatar information unique to each participant, and the participant management information for managing multiple participants who are simultaneously participating in and viewing the meeting in the virtual meeting rooms.

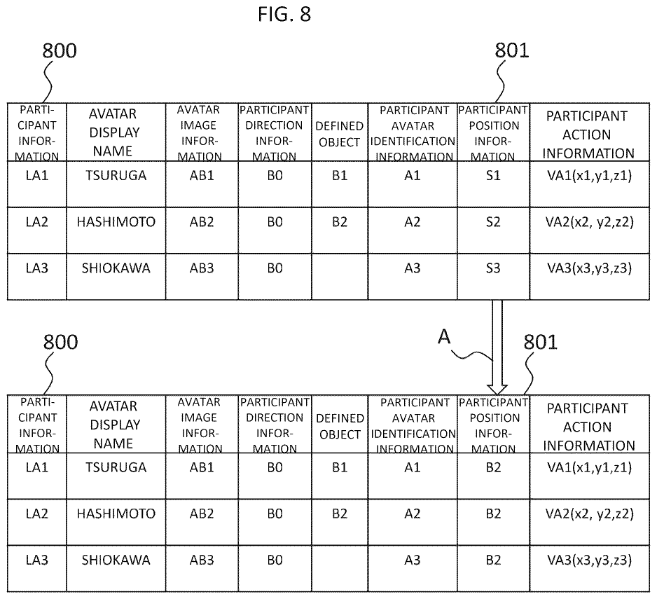

The action information about the participants holds the actions, such as nodding, standing, sitting, and moving, as the vector information for use in moving the avatar. In FIG. 8, participant action information 802 is represented as the vector information indicating the action direction of each avatar using xyz three-dimensional coordinates, expressed as VAn (xn, yn, zn) (where n is a subscript uniquely indicating the avatar).

With the system configuration described above, in each of the HMD G1, G2, G3 worn by the participants, while each of the participants is participating in the meeting held in the virtual meeting room, he or she can add the action information about another participant who is different from him or her on the avatar of the other participant, which is a computer-generated image (virtual reality image) representing the other participant, and superimpose and display it on the image in the virtual meeting room. This enables each participant to participate in the meeting through his or her own avatar.

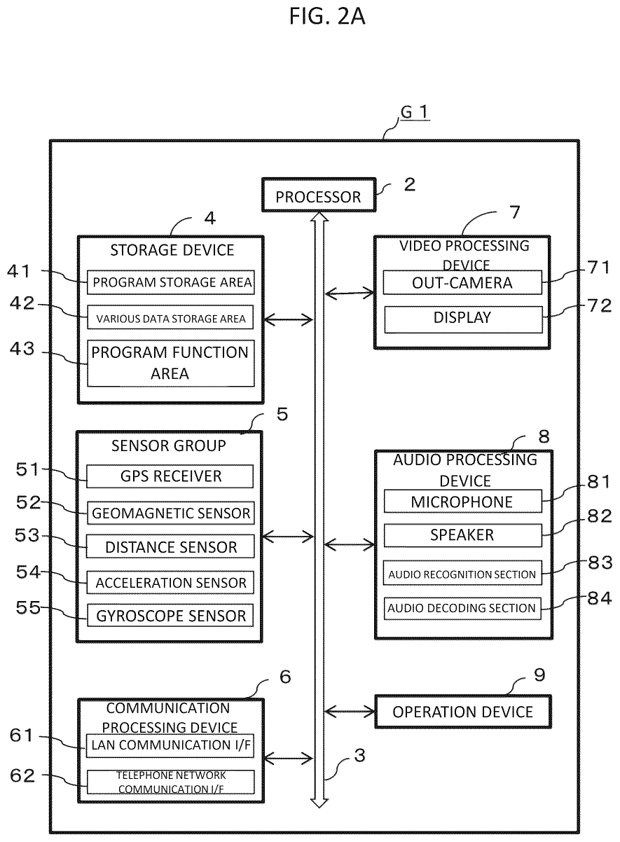

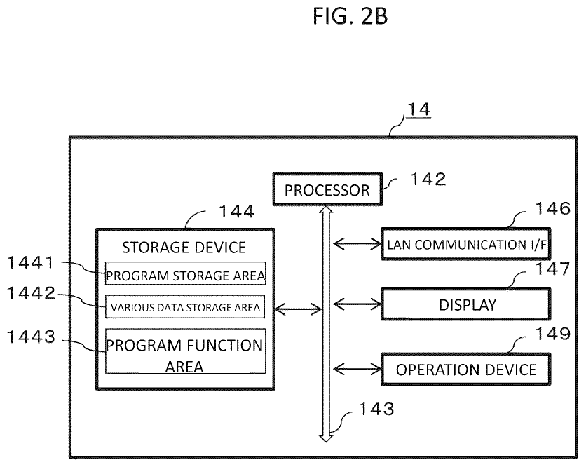

Next, an HMD according to the present embodiment, which is a head-mounted video display device, will be described with reference to the drawings. FIG. 2A is a hardware configuration diagram illustrating an example of the internal configuration of the HMD. In the following, the HMD G1 will be exemplified, however, the explanation relating to FIG. 2 is also applied to the HMD G2 and the HMD G3 as the configurations of the HMD 1, the HMD 2, and the HMD 3 are the same from each other.

In FIG. 2A, the HMD G1 includes a processor 2, a system bus 3, a storage device 4, a sensor group 5, a communication processing device 6, a video processing device 7, an audio processing device 8, and an operation device 9.

The processor 2 is a microprocessor unit that controls the overall operations of the HMD G1 in accordance with a predetermined operation program, and mainly performs processing such as receiving input from a user of the HMD G1, transmitting and receiving information with the external server 14 or the server 14 in response thereto, system control for processing a remote meeting based on the information above, and generating and displaying a three-dimensional image such as a virtual meeting room and an avatar image to be displayed.

The system bus 3 is a data communication path for transmitting and receiving various commands and data between the processor 2 and each configuration block within the HMD G1.

The storage device 4 includes a program storage area 41 for storing programs for controlling the operations of the HMD G1, a various data storage area 42 for storing various data such as operation setting values, detection values from sensors which will be described later, and objects including content, and a rewritable program function area 43 such as a work area for use in various program operations.

The storage device 4 is capable of storing operation programs downloaded through a network and various data created by the operation programs. The storage device 4 is also capable of storing content such as videos, still images, and audio downloaded through the network.

Furthermore, the storage device 4 is capable of storing data such as videos and still images captured using an out-camera 71.

The storage device 4 is necessary to retain the stored information even while the power is not supplied to the HMD G1 from the outside. Therefore, for example, a semiconductor memory device such as a flash ROM or an SSD (Solid State Drive), or a magnetic disk drive such as an HDD (Hard Disk Drive) is used for the storage device 4.

The operation programs stored in the storage device 4 can be updated and their functions can be extended by carrying out the download processing from each server device on the network.

The sensor group 5 is a group of various sensors for detecting the state of the HMD G1. The sensor group 5 includes a GPS receiver 51 for receiving radio waves from the GPS (Global Positioning System), which is one type of the global navigation satellite system (GNSS), a geomagnetic sensor 52, a distance sensor 53, an acceleration sensor 54, and a gyroscope sensor 55.

With the sensor group 5, it is possible to detect the position, tilting, direction, motions, and the like of the HMD G1. The HMD G1 may further include other sensors such as an illuminance sensor, a proximity sensor, and the like.

Furthermore, wearing a device paired with those sensors to the hand or arm allows the motion of the hand or arm to be detected. Utilizing the sensor group 5 enables detection of the actions such as clapping hands, shaking the head or hands, moving the hands up and down, standing, sitting, stepping, jumping, and the like.

The communication processing device 6 includes a LAN communication I/F 61 and a telephone network communication I/F 62. The LAN communication I/F 61 is connected to a network such as the Internet via an access point or the like, and transmits and receives data with each server device on the network. The connection with the access point or the like may be carried out by wireless connection such as Wi-Fi (registered trademark). The LAN communication I/F 61 transmits and receives data with the server 14, and therefore, it corresponds to the second communication interface.

The telephone network communication I/F 62 carries out telephone communication (calls) and data transmission and reception by wireless communication with a base station or the like of a mobile telephone communication network.

Communication with the base station or the like may be carried out by other communication methods such as W-CDMA (Wideband Code Division Multiple Access) (registered trademark), GSM (Global System for Mobile communications) (registered trademark), LTE (Long Term Evolution), or 5G.

Each of the LAN communication I/F 61 and the telephone network communication I/F 62 is provided with an encoding circuit, a decoding circuit, an antenna, and the like. The communication processing device 6 may further include other communication interfaces such as a Bluetooth (registered trademark) communication interface or an infrared communication interface.

The video processing device 7 includes the out-camera 71 and a display 72.

The out-camera 71 is a camera unit that inputs visible image data about the surroundings or an object by converting light input from a lens into an electrical signal using an electronic device such as a CCD (Charge Coupled Device) sensor or a CMOS (Complementary Metal Oxide Semiconductor) sensor.

Instead of providing the out-camera 71 or in addition thereto, a TOF (Time Of Flight) ) sensor capable of obtaining the distance to an object being captured as a distance image may be used.

Using these visible images and distance images enables accurate detection of, for example, selection of an image by means of a pointing action (hereinafter referred to as “pointing”) performed by holding the hand over a plurality of virtual reality images being displayed on the HMD G1 and pinching one of them using the thumb and index finger.

By scanning the surroundings and using the outputs of the sensor group 5 described above and the out-camera 71, a three-dimensional spatial map may be generated.

The display 72 is a display device such as a liquid crystal panel, and, for example, provides image data to the user of the HMD G1. The video processing device 7 includes a video RAM (not illustrated). The image data entered in the video RAM is displayed on the display 72.

The audio processing device 8 includes a microphone 81, a speaker 82, an audio recognition section 83, and an audio decoding section 84.

The microphone 81 converts the user's voice and the like into audio data and inputs the audio data.

The speaker 82 outputs the audio information and the like which is necessary for the user.

The audio recognition section 83 analyzes the input audio information and extracts instruction commands and the like.

The audio decoding section 84 has a function of carrying out the decoding processing (audio synthesis processing) on encoded audio signals as necessary, and a three-dimensional audio processing function for the transmission characteristics of audio.

The operation device 9 receives input of operation instructions for the HMD G1. The operation device 9 includes operation keys such as button switches placed in a row, and the like. Other operation devices may also be further provided.

Using the communication processing device 6 allows the HMD G1 to be operated by means of a separate portable terminal device connected by wired or wireless communication.

Furthermore, using the audio recognition section 83 of the audio processing device 8 allows the HMD G1 to be operated by means of audio commands for operation instructions.

It should be noted that the configuration example of the HMD G1 illustrated in FIG. 2A includes many configurations that are not essential to the present embodiment, and thus, even if these are not provided, the advantageous effects of the present embodiment would not be impaired. Furthermore, configurations not illustrated in the drawings, such as a digital broadcast receiving function and an electronic money settlement function, may be further added.

FIG. 2B is a hardware configuration diagram illustrating an example of the internal configuration of a server.

In FIG. 2B, the server 14 includes a processor 142, a system bus 143, a storage device 144, a LAN communication I/F 146, a display 147, and an operation device 149. The LAN communication I/F 146 transmits data necessary for displaying avatars to the HMD G1 to the HMD G3, and therefore, it corresponds to the first communication I/F.

The storage device 144 includes a program storage area 1441 for storing programs for controlling the operations of the server 14, various data storage area 1442 for storing a participant management table, avatars, and content data which will be described later, and a rewritable program function area 1443 such as a work area used in various program operations.

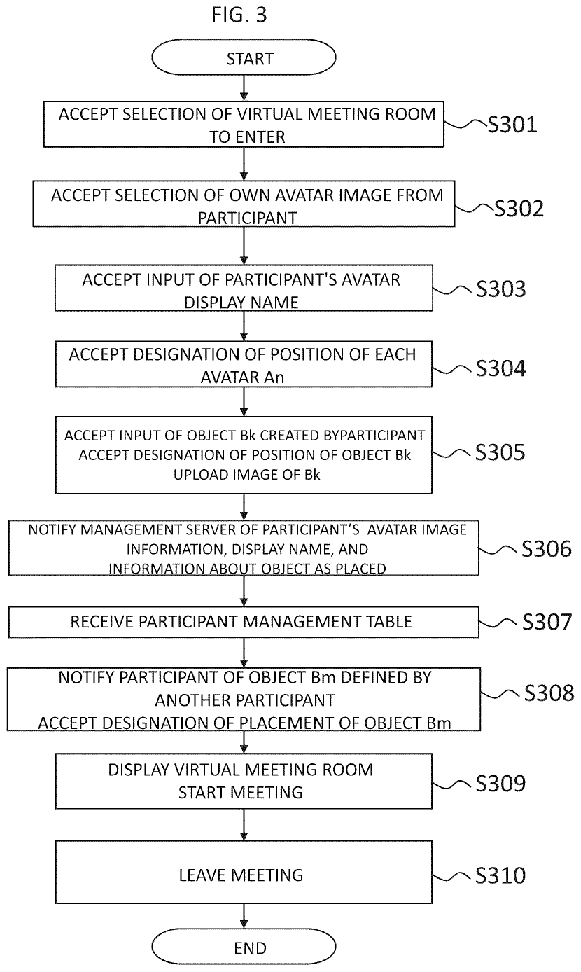

Next, an overview of the remote meeting system according to the present invention will be described. First, a detailed explanation will be given, using FIG. 3 to FIG. 10, regarding the process in which the participant P1, the participant P2, and the participant P3, who are supposed to participate in a meeting, select and enter their preferred virtual meeting rooms, respectively.

FIG. 3 is a flowchart illustrating a processing procedure by an HMD for entering a virtual meeting room. In the following, an example of a processing procedure performed when the participant P1 (FIG. 1) enters a virtual meeting room will be described step by step. It is assumed that the information such as the number of participants who are supposed to participate in the meeting, and the like is registered in advance in the remote meeting system.

Step S301: Accept the input of selection of the virtual meeting room to enter. The HMD G1 transmits the selected virtual meeting room to the server 14.

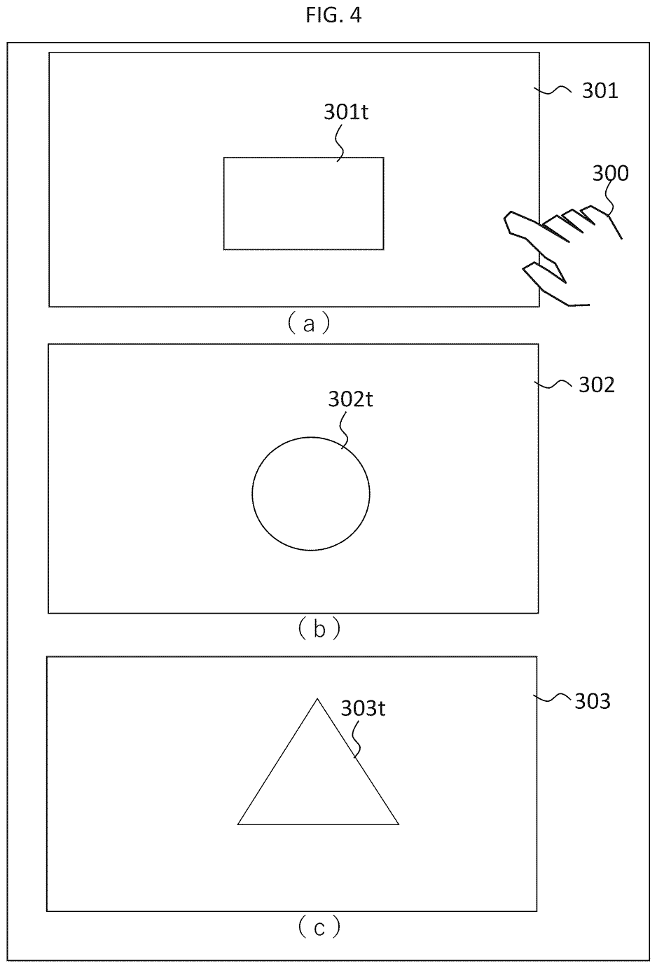

FIG. 4 illustrates a screen for selecting a virtual meeting room. The virtual meeting room selection screen illustrated in FIG. 4 is distributed from the server 14 through the network to the HMD G1, the HMD G2, and the HMD G3, which are worn by the participants who are participating in the meeting, respectively.

In FIG. 4, three virtual meeting rooms 301, 302, 303 are displayed as the selectable virtual meeting rooms. A square table 301t is placed in the virtual meeting room 301, a round table 302t is placed in the virtual meeting room 302, and a triangular table 303t is placed in the virtual meeting room 303. The shapes of the meeting rooms and tables are registered in advance in the server 14 (FIG. 1).

Each participant is allowed to freely select any of the three virtual meeting rooms 301, 302, 303.

For example, for selecting a virtual meeting room to enter, a user may put a hand 300 over the display position of any of the virtual meeting rooms 301, 302, 303 being displayed, and perform a pointing action to input his or her selection.

Step S302: Accept the selection of the own avatar image from the participant P1. For selecting an avatar image, an avatar selection screen (not illustrated) is used. The HMD G1 accepts, as the input, the avatar image selected by pointing from among the avatar images displayed on the avatar selection screen.

Step S303: Accept the input of the own name or the display name such as the nickname from the participant P1. How it is input is not particularly limited, and the HMD G1 accepts a pointing action performed for the displayed characters (for example, a software keyboard) as the input. Alternatively, input by means of audio or other methods may be used.

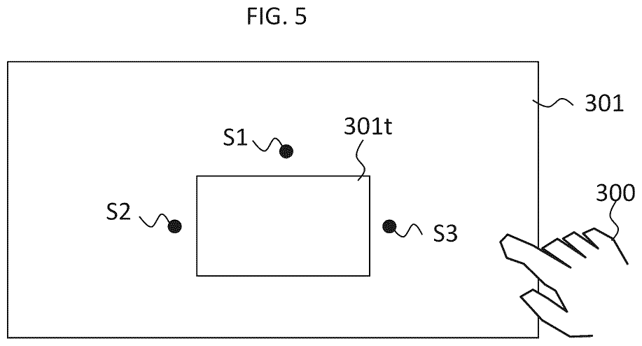

Step S304: Next, as illustrated in FIG. 5, accept the placement of avatars of participants who are supposed to participate in the meeting.

FIG. 5 is a schematic diagram illustrating that placement of avatars An is decided.

As illustrated in FIG. 5, on the display 72 of the HMD G1, the virtual meeting room 301 selected by the participant P1 in the previous step S301 is displayed. The participant P1 places the avatars An (n=1, 2, 3 . . . ) within the virtual meeting room 301.

Specifically, the example in which the avatar of the participant P1 is A1, the avatar of the participant P2 is A2, and the avatar of the participant P3 is A3 will be described below. The participant P1 firstly selects a position S1 in the virtual meeting room 301 as a seat position for his or her own avatar A1 by pointing. Next, a position S2 is selected as a seat position for the avatar A2. Then, a position S3 is selected as a seat position for the avatar A3. In this example, for the convenience of explanation, S1, S2, S3 will be described as corresponding to the seat positions illustrated in FIG. 5, respectively, however, they are not particularly limited thereto, and the seat positions to be decided by pointing can be freely selected within the virtual meeting room 301.

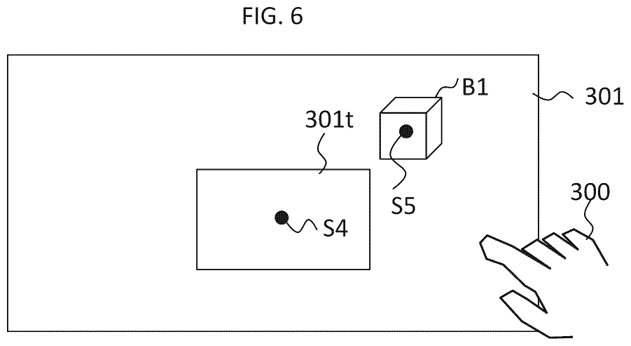

Step S305: As illustrated in FIG. 6, the HMD G1 accepts the input of objects Bk (k=1, 2, . . . ) to be placed in the virtual meeting room 301.

FIG. 6 is a schematic diagram illustrates designation of the positions of the objects Bk to be placed in a virtual meeting room.

The participant P1 points to a position S4 which is a center portion of the table 301t in the virtual meeting room 301 to input the center portion of the table 301t as an object B0. Alternatively, the object B0 may be registered, as the center of the table, in advance in the remote meeting system.

Then, the participant P1 points to a position S5 on which an object is to be placed, and specify the object as an object B1. The object is a three-dimensional object which has been created by himself or herself and is to be placed in the virtual meeting room 301 and used for discussion. Furthermore, a three-dimensional image of the object created by the participant P1 is uploaded as image data about the object B1 to the server 14.

In the case where an object registered in advance in the remote meeting system can be downloaded from the server 14 and displayed, it may be selected and placed as the object B1.

In the following, it is assumed that steps S301 to S305 described above have been performed by the participants P1 to P3, respectively.

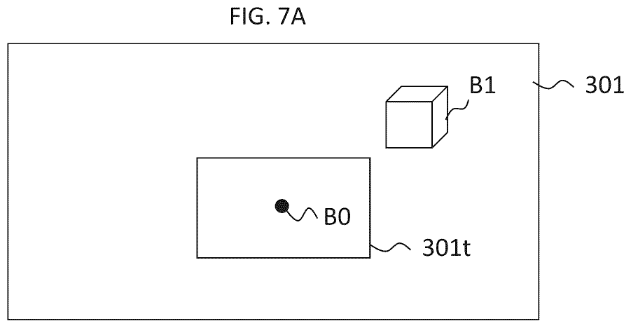

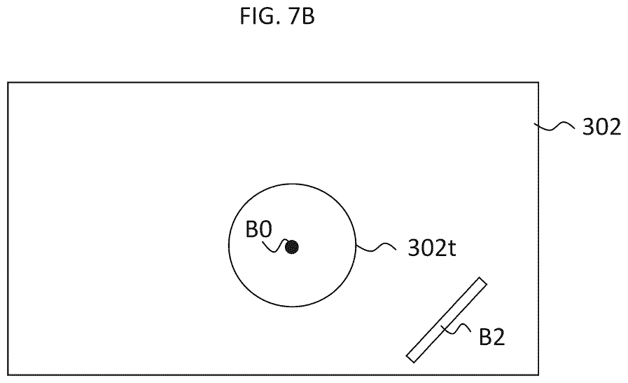

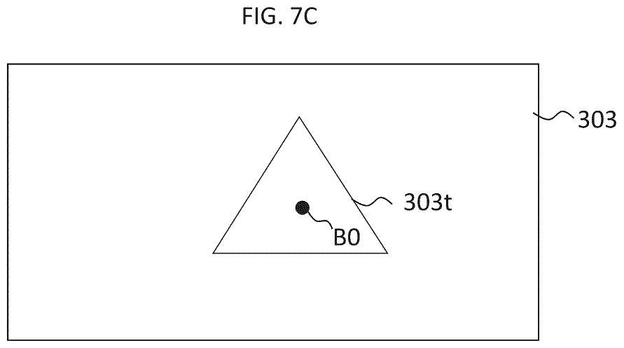

FIG. 7A is a schematic diagram as viewed from above, illustrating the virtual meeting room 301 selected by the participant P1, FIG. 7B is a schematic diagram as viewed from above, illustrating the virtual meeting room 302 selected by the participant P2, and FIG. 7C is a schematic diagram, as viewed from above illustrating the virtual meeting room 303 selected by the participant P3.

As illustrated in FIG. 7A, in the virtual meeting room 301, the table 301t and the object B1 (object) placed by the participant P1 are placed.

As illustrated in FIG. 7B, in the virtual meeting room 302, the table 302t and an object B2 of a whiteboard, which has been created by the participant P2, are placed.

The object B2 is a three-dimensional image created by the participant P2 and uploaded to the server 14 (in the case where a whiteboard is registered in advance in the remote meeting system, it may be selected and placed as the object B2).

As illustrated in FIG. 7C, in the virtual meeting room 303, the table 303t is placed. The participant P3 has not created nor placed any object.

Step S306: The avatar image information, display name, and placed object information, which were selected and defined by each of the participants P1, P2, P3 in steps S301 to S305 described above, are transmitted from the HMD G1 of the participant via the wireless router R1, from the HMD G2 via the wireless router R2, and from the HMD G3 via the wireless router R3, respectively, through the network 13 to the server 14. Then, the server 14 creates a participant management table 800 as illustrated in FIG. 8 as the information about each meeting participant.

Upon start of the meeting or participation in the meeting, participant numbers LAn (n=1, 2, 3 . . . ) of participant's own included in the participant list is notified from the server 14.

The server 14 notifies a participant number LA1 to the HMD G1 worn by the participant P1, a participant number LA2 to the HMD G2 worn by the participant P2, and a participant number LA3 to the HMD G3 worn by the participant P3. The number n is assigned in the order in which each participant has performed the entry processing. The same applies to k of the objects Bk. The “participant number” corresponds to participant identification information that uniquely identifies each participant during the current remote meeting.

FIG. 8 illustrates a participant management table for use in the remote meeting system.

The participant management table 800 illustrated in FIG. 8 is created such that the “avatar display name”, which is the display name of the avatar of the participant, input by each participant when entering the virtual meeting room, the “avatar image information” selected by each meeting participant, the “participant direction information” indicating the direction in which each participant is facing, the “defined object” defined by each participant, and the “participant position information” as the information about the position of each participant in the virtual meeting room are associated with the participant number LA1 of the participant P1, the participant number LA2 of the participant P2, and the participant number LA3 of the participant P3, respectively. The number is left blank after leaving.

The participant management table 800 has the following items for each of the participant numbers LA1 to LA3.
“Participant information”: The information for identifying the participant, which was assigned when each of the participants P1 to P3 enters the virtual meeting room.
“Avatar display name”: The name or nickname displayed near the avatar, which was input by each participant in step S303 when entering the virtual meeting room.
“Avatar image information”: The number of the avatar image selected by each participant in step S302.
“Participant direction information”: The objects Bk or avatars An present in each virtual meeting room in the direction in which each participant is facing.
“Defined object”: The objects Bk created or selected and placed by each participant in step S305.
“Participant avatar identification information”: The information for identifying the avatars An used by participants Pn. An image used for an avatar is represented by ABn, and thus, in the case where the participant P1 changes the avatar image, the avatar image used for the avatar A1 may change from AB1 to AB2.
“Participant position information”: The position in the virtual meeting room where each participant is present to be described later, which is defined as Sm (m indicates, for example, a position where the avatars An can be placed in the virtual meeting room). For example, in the case where S1 is listed in an item 801 (FIG. 8) for the position of the participant P1 (upper row in FIG. 8), it means that the participant P1's own avatar A1 is displayed at the position indicated by S1. It shows that the avatar indicated by the avatar A1 of the participant P1 selected in step S304 is present at the position S1 of his or her own seat. In the case where A2 is listed in the item 801 for the position of the participant P1, it means that the participant P1's own avatar A1 is displayed near an avatar image AB2 of the participant P2. In the case where any of the objects Bk (object) included in the virtual meeting room is listed in the item 801 (lower row in FIG. 8), it means that the participant P1's own avatar A1 is present near the object Bk. In the case where the item 801 is changed as shown by an arrow A, it shows the shift in which the avatar images AB1 to AB3 displayed at S1 to S3, respectively, have gathered near the object B2 and displayed. Furthermore, in the case where the participant position information indicates that another participant is the destination of movement, it may mean that the participant is standing in front of that person. In the case where multiple participants move to the same place, the system may prohibit entry of the same value in the multiple fields of the item 801. Alternatively, moving nearby, in other words, entry of the same value in the multiple fields of the item 801 may be allowed so that, for example, the avatar images AB1, AB2 can be displayed side by side.
“Participant action information”: The information representing an action vector of each avatar represented in three-dimensional coordinates. The stationary state is represented by (0, 0, 0).

All items of information included in the participant management table 800 are broadcasted from the server 14 through the network 13 to all HMDs of all participants, in other words, from the wireless router R1 to the HMD G1, from the wireless router R2 to the HMD G2, and from the wireless router R3 to the HMD G3.

Step S307: Each of the HMD G1, the HMD G2, and the HMD G3 receives the data about the participant management table 800 broadcasted from the server 14 as described above.

Step S308: The HMD G1 which has received the broadcasted participant management table 800 finds, based on the “defined object” included in the participant management table 800, that the object B2 (whiteboard), which is the object defined by another participant and is other than the object B1 (object) defined by himself or herself, is present. The HMD G1 provides the participant P1 with a notification to let him or her select a position in the virtual meeting room 301 for which the object B2 (whiteboard) is to be displayed, and accepts the input of designation by, for example, pointing, performed by the participant P1 in response thereto.

Step S309: The avatar images AB1 to AB3 for all the avatars A1 to A3, the object B1 (object), and the object B2 (whiteboard) in the virtual meeting room 301 are processed by the three-dimensional graphic processing to be displayed on the HMD G1, and then the meeting starts.

Step S310: Upon end of the meeting, meeting room leaving processing is carried out to end the meeting. In the example described above, the avatar image of each avatar is selected from among those registered in the video display system according to the present embodiment, however, each participant may upload a unique avatar image created by himself or herself to the distribution server. In the same manner, the object B1 and the object B2 may also be selected from among those already registered in the system, or may be the ones created by each participant and uploaded to the distribution server.

During the meeting, increases or decreases in the participant management table 800 which is caused by participation or leaving of participants are notified. When a participant joins or leaves, it is notified to the server 14 and broadcasted from the management server. At the start of the meeting or when participating in the meeting, the participant receives his or her own participant number LAn. After leaving, the number is left blank.

In the present embodiment, an example is illustrated in which the notification information from each HMD is managed by the server 14 in steps S301 to S306, however, the information may be directly broadcasted between the participants' HMDs without going through the management server so that the HMDs can manage and update the participant management table 800.

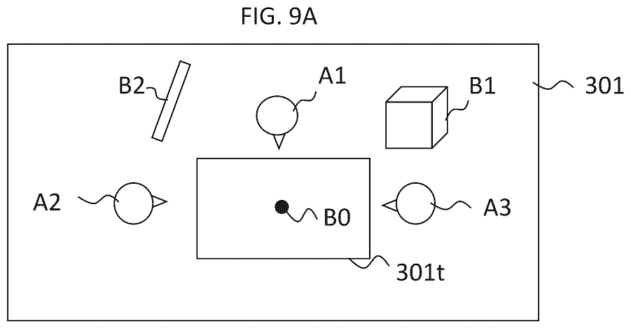

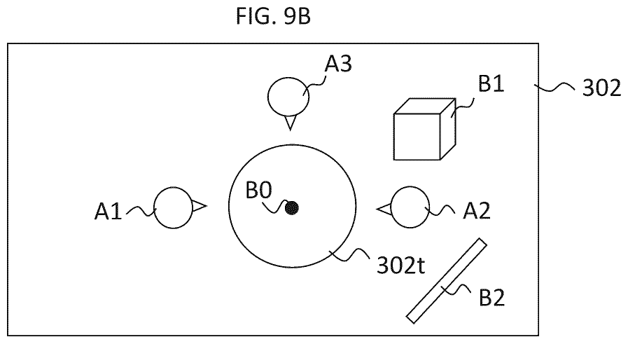

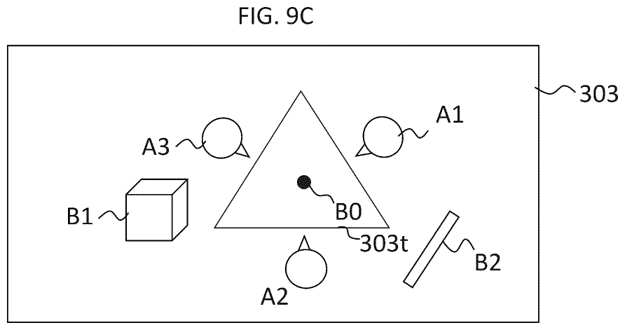

FIG. 9A is a schematic diagram of the virtual meeting room 301 as viewed from above, where the participant P1 who performed the processes up to step S308 described above has entered, FIG. 9B is a schematic diagram of the virtual meeting room 302 as viewed from above, where the participant P2 who performed the processes up to step S308 described above has entered, and FIG. 9C is a schematic diagram of the virtual meeting room 303 as viewed from above, where the participant P3 who performed the processes up to step S308 described above has entered.

In the virtual meeting rooms illustrated in FIG. 9, based on the “participant direction information” included in the participant management table 800 illustrated in FIG. 8, each participant is facing the object B0, which corresponds to the table in the virtual meeting room, the object B1 (object) and object B2 (whiteboard), which were defined and placed by the participants P1 and P2, respectively, are placed, and the avatars A1, A2, A3 are displayed at their own seat positions S1, S2, S3, respectively.

Each of FIG. 9A and FIG. 9B illustrates the example in which the participants P1, P2 have placed the object B2 near them so that they can write on the whiteboard and easily make a discussion during the meeting, and FIG. 9C illustrates the example in which the whiteboard is placed in front of the participant P3 (avatar A3), who merely listens to the discussion between the avatars A1, A2.

As described above, the avatars An or objects Bk being displayed are used for defining the orientation information about the direction in which each participant who is participating in the remote meeting is looking at in the virtual meeting room, and the position information about each participant in the virtual meeting room. This enables the avatars An or the objects Bk to be freely placed in each of the virtual meeting rooms 301, 302, 303 where the participants P1, P2, P3 have entered, respectively, and thus, each participant to participate in a remote meeting without feeling uncomfortable in the virtual meeting room that suits his or her preference.

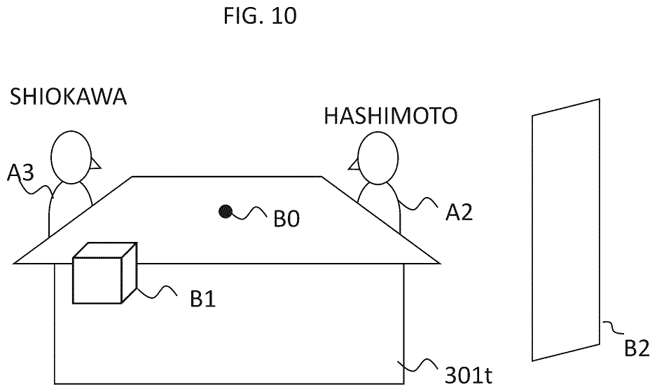

FIG. 10 is a schematic diagram illustrating the image being displayed on the HMD G1. This schematic diagram illustrates, as an example, the image being displayed on the HMD G1 of the participant P1 in step S308 of FIG. 3 described above, in which the avatar A2 of the participant P2, the avatar A3 of the participant P3, the table 301t of the virtual meeting room 301, the object B1 (object), and the object B2 (whiteboard) are placed.

Based on the participant management table 800, above the head of the avatar A2 (or nearby), the name “HASHIMOTO” of the participant P2 is displayed, and in the same manner, above the head of the avatar A3 (or nearby), the name “SHIOKAWA” of the participant P3 is displayed. The participant P1 is the person himself or herself who has entered the virtual meeting room 301 and the virtual meeting room 301 is displayed based on a first-person perspective, and thus the avatar A1 is not displayed in FIG. 10.

In this way, even in the case where the facial image registered as the avatar is completely different from (not resembling) the participant himself or herself, it is possible to display the names of avatars and make it easier to identify who is speaking.

Next, the video of the actions of the avatars A1, A2, A3 in the virtual meeting room 301 for the participant P1, the virtual meeting room 302 for the participant P2, and the virtual meeting room 303 for the participant P3, in which the actions of the avatars A1, A2, A3 after the entry is completed in step S308 are reflected, will be described.

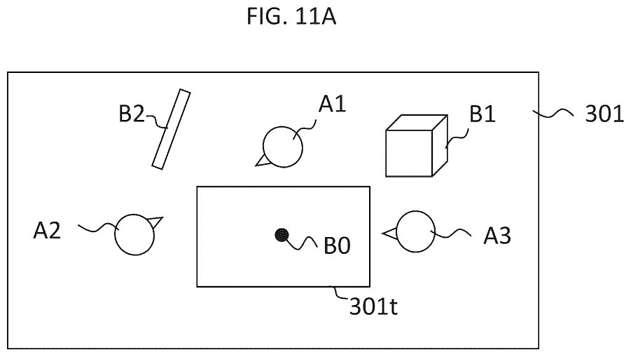

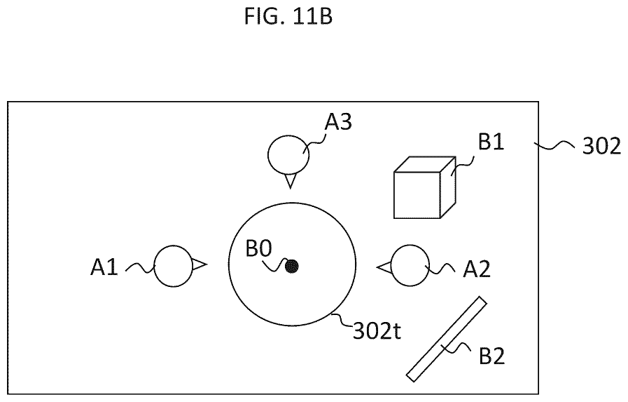

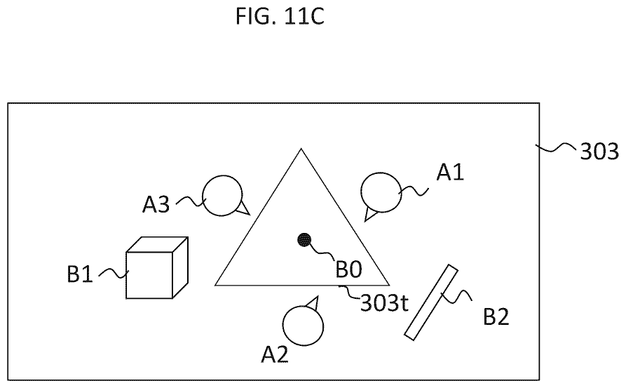

FIG. 11A is a schematic diagram illustrating the configuration of the virtual meeting room 301, FIG. 11B is a schematic diagram illustrating the configuration of the virtual meeting room 302, and FIG. 11C is a schematic diagram illustrating the configuration of the virtual meeting room 303.

FIG. 11 illustrates from above that the avatars, the table 301t to the table 303t as the objects B0 (tables), the object B1 (object), and the object B2 (whiteboards) are placed in the virtual meeting rooms 301 to 303 where the participants P1, P2, P3 have entered. The participant P1 is facing the avatar A2 for conversation, and the participant P2 is facing the avatar A1 for conversation. The other conditions are the same as those illustrated in FIG. 9A to FIG. 9C.

As illustrated in FIG. 11A, when the participant P1 looks at the avatar A2 for conversation, it is detected that the direction information about the direction in which the participant P1 is looking at, which is detected based on the angle information detected by the sensor group 5 of the HMD G1, such as the acceleration sensor 54 and the gyroscope sensor 55, is indicative of the avatar A2 being displayed on the display 72 of the HMD G1.

The direction information about the direction in which the participant P1 is looking at is transmitted from the HMD G1 to the server 14 through the wireless router R1 and the network 13.

The server 14 updates the direction in which the participant P1 is looking at included in the participant management table 800 to be the avatar A2.

In the same manner, as illustrated in FIG. 11B, when the participant P2 looks at the avatar A1 to have a conversation, it is detected that the direction information about the direction in which the participant P2 is looking at, which is detected based on the angle information detected by the sensor group 5 of the HMD G2, such as the acceleration sensor 54 and the gyroscope sensor 55, is indicative of the avatar A1 being displayed on the display 72 of the HMD G2. The information thus detected is transmitted from the HMD G2 to the server 14 through the wireless router R2 and the network 13.

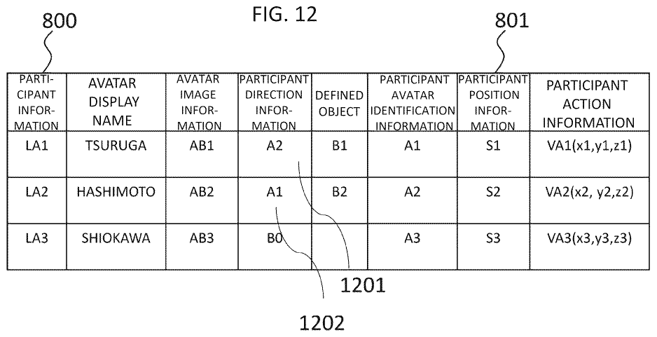

FIG. 12 illustrates the participant management table 800 updated in response to the actions of the participant P1 and participant P2 described above.

Based on the action of the participant P1, an item 1201 of the participant direction information in the management table is updated to the avatar A2, and based on the action of the participant P2, an item 1202 of the participant direction information in the management table is updated to the avatar A1.

The participant management table 800 is broadcasted to the HMD G1, the HMD G2, and the HMD G3 via the route described above at regular intervals (or in response to the update of the items transmitted from the HMDs G1, G2, G3 worn by the participants P1, P2, P3).

Based on the information as broadcasted, as illustrated in FIG. 11A, the HMD G1 carries out the display control for causing the face of the avatar A2 of the participant P2 to be oriented toward the avatar A1.

In the same manner, as illustrated in FIG. 11B, the HMD G2 carries out the display control for causing the face of the avatar A1 of the participant P1 to be oriented toward the avatar A2.

Furthermore, as illustrated in FIG. 11C, the HMD G3 carries out, in the same manner, the display control for causing the face of the avatar A1 of the participant P1 to be oriented toward the avatar A2 and causing the face of the avatar A2 to be oriented toward the avatar A1.

As described above, the avatars An or objects Bk being displayed are used for defining the orientation information about the direction in which each participant, who is participating in the remote meeting, is looking at in the virtual meeting room, and the position information about each participant in the virtual meeting room. This enables each HMD to carry out the display control for causing the placed avatars who are having a conversation therebetween to face each other even in the case where each participant places the avatars at the tables of different shapes, and thus enables each participant to feel as if he or she was actually participating in the meeting.

In the explanation above, the example of obtaining an orientation in which a participant is looking at based on the angle information detected by the sensor group 5 of the HMD, such as the acceleration sensor 54 and the gyroscope sensor 55, has been described. However, for the purpose of further improvement in the detection accuracy, the line of sight of the participant may be detected using a line-of-sight sensor (not illustrated), so that it can be detected that the direction in which the participant is looking at is indicative of an avatar or an object being displayed on the display 72 of the HMD.

As the processing of detecting the line of sight, a well-known technique generally used as the eye tracking processing may be used. For example, in a method using corneal reflection, such a technique has been known that involves irradiating the infrared LED (Light Emitting Diode) onto the face and capturing it with an infrared camera, and using the position of the reflected light on the cornea (corneal reflection) generated by the infrared LED irradiation as a reference point, detecting the line of sight based on the position of the pupil relative to the position of the corneal reflection.

This enables what the participant is actually looking at to be detected, for example, even when multiple avatars or objects are placed close together.

It goes without saying that, using a line-of-sight sensor, the acceleration sensor 54, and the gyroscope sensor 55 enables further improvement in the accuracy of detection of the orientation in which the participant is looking at.

### Explanation of Display when Orientation of Face has Changed

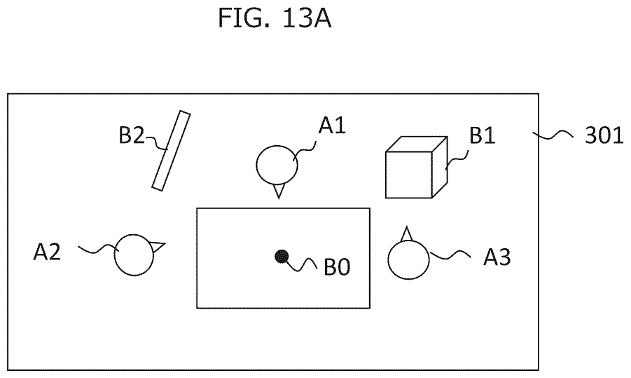

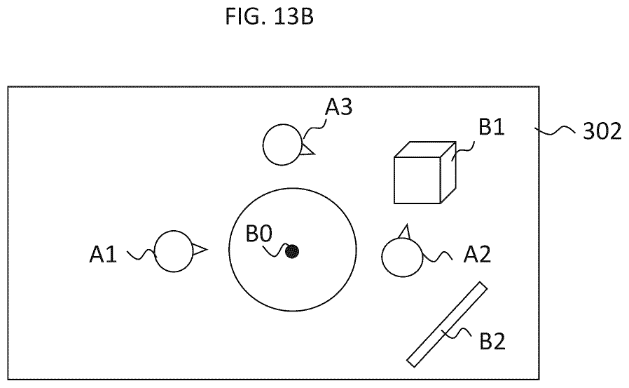

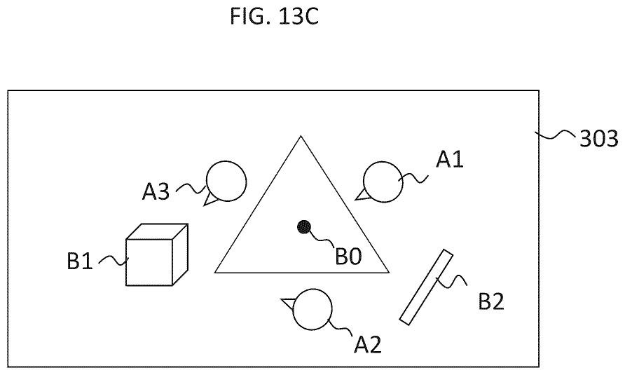

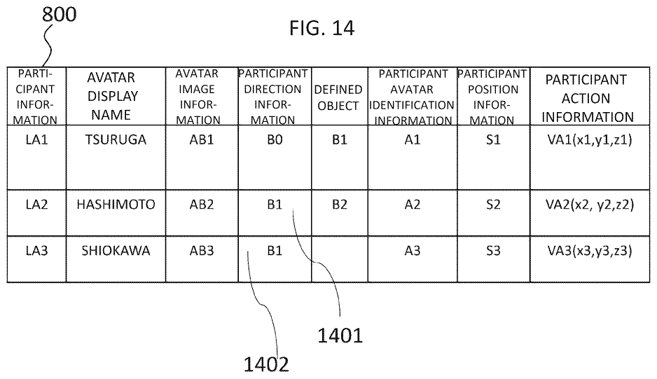

Next, with reference to FIG. 13 and FIG. 14, the display of the virtual meeting room when each avatar has changed the orientation of his or her face will be described.

Each of FIG. 13A to FIG. 13C is a schematic diagram illustrating the configuration of a virtual meeting room after avatars have changed the orientation of their faces. FIG. 13A is a schematic diagram illustrating the configuration of the virtual meeting room 301, FIG. 13B is a schematic diagram illustrating the configuration of the virtual meeting room 302, and FIG. 13C is a schematic diagram illustrating the configuration of the virtual meeting room 303. In the same manner as FIG. 11A to FIG. 11C, FIG. 13A to 13C illustrate the virtual meeting rooms 301 to 303 where the participants P1, P2, P3 have entered, respectively, when viewed from above.

The participant P1 (avatar A1) is detected as facing the front direction of FIG. 13A based on the angle information about the HMD G1. The object B0 is present in front of the participant P1, and accordingly, the direction in which the participant P1 is facing is defined using the object B0.

The participant P2 (avatar A2) illustrated in FIG. 13B is facing the direction of the object B1 (object). Based on the angle information about the HMD G2, it is detected that the direction in which the participant P2 is looking at is indicative of the object B1 (object) placed in the virtual meeting room 302.

The participant P3 (avatar A3) illustrated in FIG. 13C is facing the direction of the object B1 (object). Based on the angle information about the HMD G3, it is detected that the direction in which the participant P3 is looking at is indicative of the object B1 placed in the virtual meeting room 303.

The information thus detected is transmitted to the server 14 via a predetermined route in the same manner as described above.

FIG. 14 illustrates a participant management table for the situations illustrated in FIG. 13.

In the server 14, as illustrated in FIG. 14, the processing for updating the direction in which the participant P2 is looking at and that in which the participant P3 is looking at to the object Bl is carried out for an item 1401 and an item 1402 of the participant management table 800.

Then, the updated information about the participant management table 800 is broadcasted to the HMD G1, the HMD G2, and the HMD G3 of the participants, respectively, via a predetermined route.

In the HMD G1, based on the broadcasted information about the participant management table 800, the display control is carried out to cause the avatar A2 in the virtual meeting room 301 to face the object B1 and the avatar A3 to face the object B1.

In the same manner, in the HMD G2, based on the broadcasted information of the participant management table 800, the display control is carried out to cause the avatar A3 in the virtual meeting room 302 to face the object B1.

In the same manner, in the HMD G3, based on the broadcasted information of the participant management table 800, the display control is carried out to cause the avatar A2 in the virtual meeting room 303 to face the object B1.

As described above, the avatars An or objects Bk being displayed are used for defining the orientation information about the direction in which each participant, who is participating in the remote meeting, is looking at in the virtual meeting room, and the position information about each participant in the virtual meeting room. This enables the display control to be carried out by each HMD to cause the avatars placed around the tables of the different shapes by each participant to face the direction of the object which has been seen by the avatars engaged in a conversation, and thus enables each participant to feel as if he or she was actually participating in the meeting.

### Explanation of Display when Avatar has Move

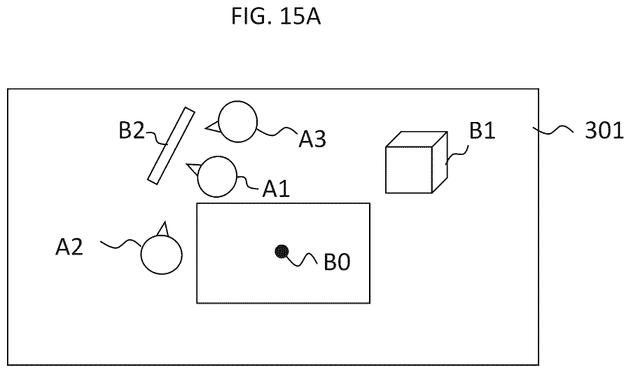

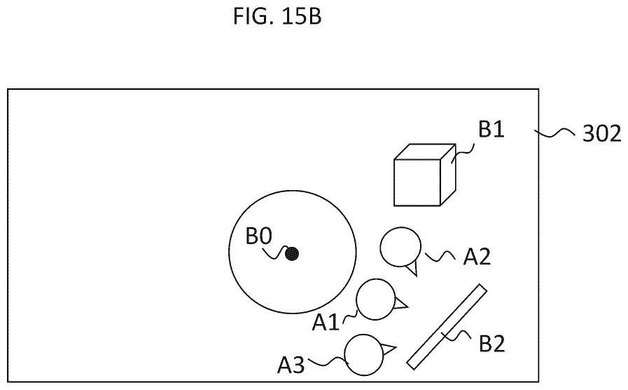

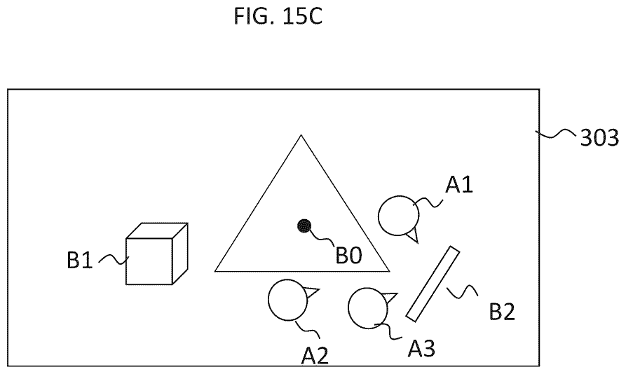

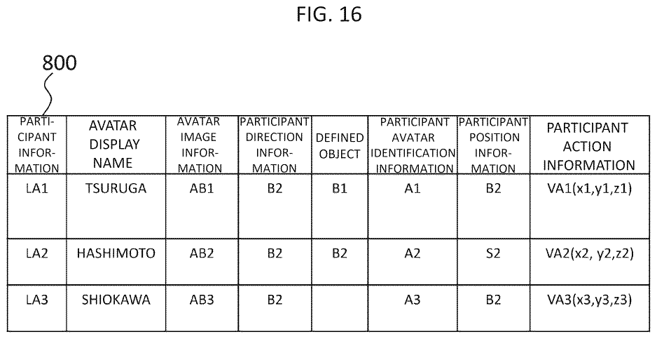

Next, with reference to FIG. 15 and FIG. 16, the display of the virtual meeting room when each avatar has moved to a position other than his or her own seat will be described.

FIG. 15 is a schematic diagram illustrating the configuration of a virtual meeting room after movement of avatars. FIG. 15A is a schematic diagram illustrating the configuration of the virtual meeting room 301, FIG. 15B is a schematic diagram illustrating the configuration of the virtual meeting room 302, and FIG. 15C is a schematic diagram illustrating the configuration of the virtual meeting room 303. Each of FIG. 15A to FIG. 15C illustrates the avatar A1 to the avatar A3 when the participant P1 and the participant P3 are discussing at the position of the object B2 (whiteboard) with facing the direction of the whiteboard B2 and the participant P2 is looking in the direction of the whiteboard B2 at his or her own seat position S2. FIG. 16 illustrates a participant management table for the situation illustrated in FIG. 15.

The participant P1 (avatar Al) in FIG. 15A is facing the direction of the object B2 (whiteboard) at the position of the object B2 (whiteboard). Based on the angle information about the HMD G1, it is detected that the direction information about the direction in which the participant P1 is looking at is indicative of the object B2.

The participant P1 may actually move in the virtual meeting room 301 toward the front of the object B2 (whiteboard) and write on the whiteboard, or, without moving, may point to the whiteboard in the displayed image and write on the whiteboard. This allows the display control to be carried out to cause the avatar A1 of the participant P1 to move in the other virtual meeting rooms 302, 303 toward the front of the object B2, or to move instantly thereto.

This causes the display position of the avatar A1 to be set to the object B2 (whiteboard). Furthermore, the HMD G1 notifies the server 14 via a predetermined route that, in the participant management table 800 of FIG. 16, the “participant direction information” about the participant number LA1 is indicative of the object B2 and the “participant position information” thereof is indicative of the object B2.

The participant P2 (avatar A2) in FIG. 15B is facing the direction of the object B2 (whiteboard) at his or her own seat. Based on the angle information about the HMD G2, it is detected that the direction information about the direction in which the participant is looking at is indicative of the object B2, and the position is indicative of the display position S2 of the avatar A2, which is his or her own seat.

Then, the HMD G2 notifies the server 14 via a predetermined route that, in the participant management table 800 of FIG. 16, the “participant direction information” about the participant number LA2 of the participant P2 is indicative of the object B2 and the “participant position information” thereof is indicative of the display position S2 of the avatar A2, which is his or her own seat.

In the same manner as the participant P1 (avatar A1), the participant P3 (avatar A3) in FIG. 15C is facing the direction of the object B2 (whiteboard) at the position of the object B2 (whiteboard). Based on the angle information about the HMD G3, it is detected that the position of the avatar A3 is indicative of the object B2 (whiteboard).

Then, the HMD G3 notifies the server 14 via a predetermined route that, in the participant management table 800 of FIG. 16, the “participant direction information” about the participant number LA3 is indicative of the object B2 and the “participant position information” thereof is indicative of the object B2.

The server 14 updates the participant management table 800 based on the information notified from the HMD G1, the HMD G2, and the HMD G3, and the updated information included in the participant management table 800 is broadcasted to the HMD G1, the HMD G2, and the HMD G3 worn by participants P1, P2, and P3, respectively, via a predetermined route.

In the HMD G1, based on the information included in the participant management table 800 as broadcasted, the display control is carried out to display the avatar A2 in the virtual meeting room 301 so as to face the object B2 (whiteboard) and the avatar A3 so as to face the object B2, and also change the display position of the avatar A3 from the position S3 to the vicinity of the object B2.

Participants may broadcast their mode of movement, such as running, walking, walking slowly, or instantaneous movement.

Regardless of other participants' designation, the owner of the space of each of the virtual meeting room 301, 302, 303 (which is synonymous with the participants P1, P2, or P3) may freely determine the placement. Alternatively, it may be configured, for example, in the case where the participant P1 moves within the virtual meeting room 301, the avatar A1 would not move in the virtual meeting room 302 of the participant P2 and the virtual meeting room 303 of the participant P3. In this case, such an advantageous effect that the placement of avatars of other users is not disturbed by the movement of one user can be obtained.

In the same manner, in the HMD G2, based on the information included in the broadcast participant management table 800, the display control is carried out to display the avatar A3 in the virtual meeting room 302 so as to face the object B2, and change the display position to the vicinity of the object B2.

In the same manner, in the HMD G3, based on the information included in the broadcast participant management table 800, the display control is carried out to display the avatar A2 in the virtual meeting room 303 so as to face the object B2 (whiteboard), and change the display position to the vicinity of the object B2.

As described above, the avatars An or objects Bk being displayed are used for defining the orientation information about the direction in which each participant, who is participating in the remote meeting, is looking at in the virtual meeting room, and the position information about each participant in the virtual meeting room. This enables the display control to be carried out by each HMD to display an image in which each participant is having a discussion with the avatars of the other participants in front of the object (in this example, whiteboard), which has been arbitrarily placed in each room having the tables of different shapes, and thus enables each of all the participants to feel as if he or she was actually engaged in the meeting in front of the whiteboard.

Furthermore, in the case of applying the remote meeting system according to the present invention to, for example, seminars where specific predetermined positions do not need to be set for all participants, predetermined positions for only the instructor and a user himself or herself may be set. If there is a question or other statement from another participant, a temporary position may be provided for that participant. The avatar at that time may be that of the participant or an anonymous avatar.

In the case where meeting participants are distinguished by rank (for example, executives, etc.), specific positions may be provided for only the avatars of higher-ranked participants, and the others may be treated as audience members, with avatars displayed only when they are speaking.

Furthermore, meeting room owners may, in accordance with their preference, rank participants' avatars and set, with limitation, which avatars are provided with specific positions. The others may be treated as audience members and represented by audience avatars (such as multiple human shadows) behind the user himself or herself or in a place for audience members.

In the embodiment described above, the description has been made using the example of an immersive HMD, however, the present invention is not limited thereto. For example, an HMD to be used in the embodiment described above may be a see-through HMD for AR display. If using a see-through HMD, a participant performs 3D scanning for the room where he or she is present using the HMD or the like, create 3D data of a meeting room, and places avatars, whiteboards, and objects in the virtual meeting room to display them in a superimposed manner.

### Second Embodiment

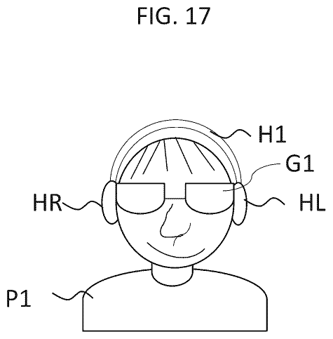

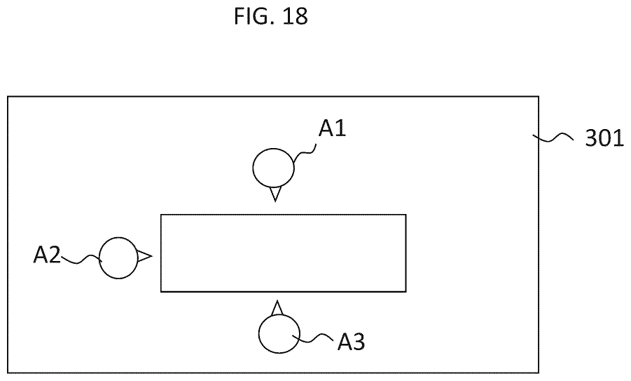

The second embodiment is an embodiment in which three-dimensional audio is used in combination. The following description will be given with reference to FIG. 17 and FIG. 18. FIG. 17 illustrates that a participant is wearing stereo headphones, and FIG. 18 is a schematic diagram illustrating placement of each avatar in a virtual meeting room.

The audio dispersion range in the virtual meeting room extends longer in the direction in which the avatar is facing, and extends relatively less in the lateral and rear directions relative to the direction in which the avatar is facing. The length of this extension is determined by the volume of the audio. Based on the audio dispersion range, an avatar positioned behind the avatar emitting the audio will hear the audio at a lower volume, and an avatar positioned farther from the audio dispersion range will also hear the audio at a lower volume.

Therefore, for example, when the participant P1 wears the stereo headphones H1 as illustrated in FIG. 17, the control of three-dimensional audio output is carried out in accordance with the audio dispersion range described above, based on the audio transmission characteristics of the virtual meeting room 301 and the “participant direction information” and “participant position information” obtained from the participant management table 800.

The control of three-dimensional audio output is carried out by a head-related transfer function decision section, a convolution operation section, and a head-related transfer function D/B which are not illustrated but provided in the audio decoding section 84. “D/B” is an abbreviation for database.

The head-related transfer function decision section decides the head-related transfer function based on the “participant direction information” and “participant position information”. The head-related transfer function is obtained by searching the head-related transfer function D/B, or by calculating based on the head-related transfer function obtained by searching the head-related transfer function D/B.

The convolution operation section performs a convolution operation for the audio signal in accordance with the head transfer function and the audio dispersion range described above of the avatar who is emitting the audio, or performs an equivalent operation so as to obtain a three-dimensional audio signal and output the audio to the speaker 82.

In the case where the avatar A1 of the participant P1 and the avatar A2 are in the positional relationship as illustrated in FIG. 18, the output of the headphones H1 is controlled such that the sound from an output portion HR is louder and the sound from an output portion HL is quieter. Depending on the audio transmission characteristics that have been set, output phase control for both the output portions may be further performed, so that the audio is controlled to be heard as if coming from slightly from the front.

Although not illustrated, a participant may arbitrarily set the length and range of the audio dispersion range described above to, for example, whisper to a certain avatar, or transmit the audio at the same volume to all avatars.

The HMD G1 and the headphones H1 may be connected with each other wirelessly by, for example, Bluetooth (registered trademark), or may be connected by wire.

Using the three-dimensional audio control described above, headphones equipped with sensors that detect head motions, such as a geomagnetic sensor, a distance sensor, an acceleration sensor, a gyroscope sensor, and the like, which are called smart earphones, may be used instead of an HMD. In this case, the headphones are used in connection with a smartphone. The video of the inside of the virtual meeting room may be displayed on the smartphone, or even if not displayed, a sense of realism as if the user was actually in the meeting with other participants in the virtual meeting room can be provided. Therefore, it is possible to use the headphones even when other remote meeting participants are using HMDs.

In the description described above, the headphones are used in connection with a smartphone, however, it may be connected to a portable information terminal, for example, a tablet or a wearable terminal, such as a smartwatch.

As the headphones H1 and the smart earphones described above, either the ones of air conduction type or bone conduction type may be used.

Air conduction headphones, which allow the user to hear air-conducted sound transmitted by air vibrations, are worn so as to contact the surface of the ear, and in particular, open-ear headphones may be worn without completely covering the ears, so that ambient sounds can enter the ears via the surroundings of the headphone. This allows the user to hear ambient sounds. Bone conduction headphones, which allow the user to hear bone-conducted sound transmitted by bone vibrations, are worn without covering the ear at all, so that ambient sounds can enter the ears as they are and be heard.

### Third Embodiment

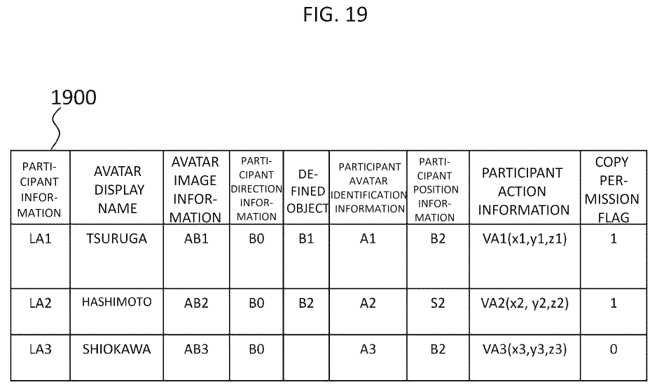

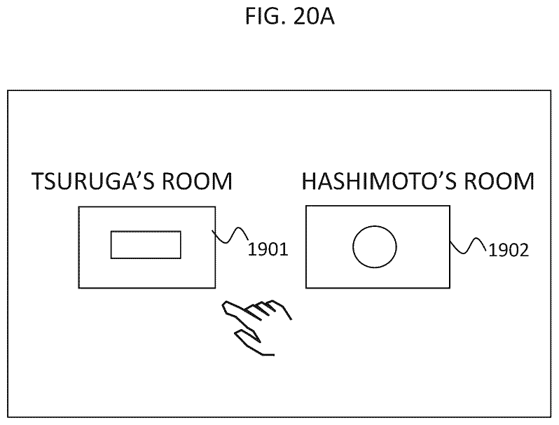

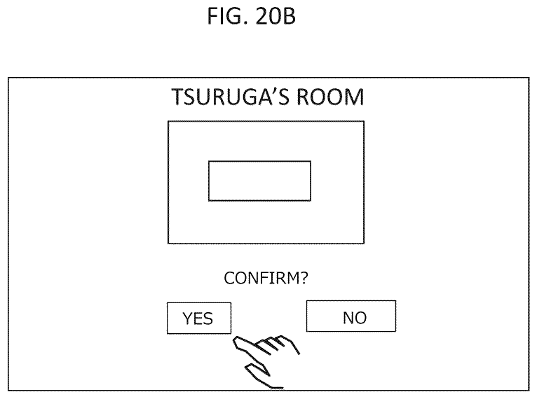

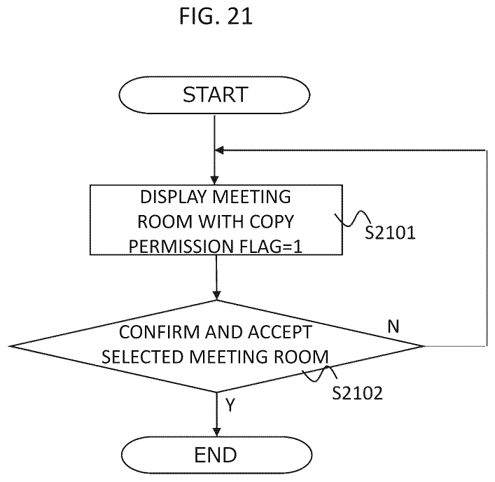

The third embodiment is an embodiment for the case in which a participant in a remote meeting copies a virtual meeting room created or selected by another participant or by the system, as well as the avatars An and the objects Bk placed in the virtual meeting room, and then participate in the meeting. The following description will be given with reference to FIG. 19, FIG. 20, and FIG. 21.

FIG. 19 illustrates a participant management table according to the third embodiment.

FIG. 19 illustrates a participant management table 1900 generated in the server 14 (FIG. 1), in which a “copy permission flag” (corresponding to duplication permission information) is added as an item to the participant management table 800.

The copy permission flag is a flag for permitting other participants to copy and use the placement of the virtual meeting room created or selected by a participant and the avatars An and objects Bk placed therein. The flag “1” indicates permission to copy, and the flag “1” indicates no permission to copy.

FIG. 20A is a schematic diagram illustrating that the virtual meeting rooms of other participants for which copying is permitted are displayed in parallel, and FIG. 20B is a schematic diagram illustrating an example of selection display of a virtual meeting room.

FIG. 20A illustrates an example of display on the HMD G3 worn by the participant P3, in which the virtual meeting room selected and set by another participant, with the “copy permission flag” item in the participant management table 1900 being “1”, is displayed. Although not illustrated in FIG. 20A, in the virtual meeting room 1901, it is assumed that the avatars An of the participants and the objects Bk are placed in the virtual meeting room 1901 selected by the participant P1 based on the remote meeting system. In the same manner, it is assumed that the virtual meeting room 1902 is the virtual meeting room created by the participant P2, and although not illustrated, the avatars An of the participants and the objects Bk are placed therein.

The participant P3 can select one of the virtual meeting room 1901 and the virtual meeting room 1902 being displayed by pointing.

FIG. 20B illustrates a display example on the HMD G3 when the participant P3 is about to confirm his or her selection of the virtual meeting room 1901. If the participant P3 points to “Yes” in this display image, the virtual meeting room 1901 is confirmed as the virtual meeting room to be copied. If “No” is selected, the display returns to that of FIG. 20A which allows the participant P3 to select the virtual meeting room to be copied again.

FIG. 21 is a flowchart illustrating a processing flow according to the third embodiment, and illustrates the processing procedure by the processor 2 for selecting a virtual meeting room with the “copy permission flag” described above “1”.

Step S2101: Display the virtual meeting room with the “copy permission flag” item in the participant management table 1900 being “1” (FIG. 20A).

Step S2102: Display the selection screen for a virtual meeting room (FIG. 20B), and if “Yes” is confirmed by pointing, the selection processing ends. If “No” is pointed, the processing returns to step S2101. Thereafter, the processing of the first and second embodiments is applied to the selected virtual meeting room.

According to this embodiment, a participant can copy and use a virtual meeting room with the “copy permission flag” being “1”. This is convenient because the participant does not have to place the avatars An and the objects Bk in the virtual meeting room by himself or herself.

Furthermore, in this embodiment, if the image displayed on the HMD G3 of the participant P3 can be selected from among a first-person image based on the position of the participant P3 in the copied virtual meeting room and a first-person image as seen from the participant who allowed the copying (assumed to be the participant P1), the participant P3 can view the first-person image as seen from the participant P1.

### Fourth Embodiment

In the embodiments described above, the remote meeting system in which a plurality of HMDs is connected with each other via the server 14 has been described, however, it is also possible to implement the same functions as those of the server 14 in each HMD without going through the server 14 but connecting the HMDs directly to each other. This enables remote meetings using avatars by connecting HMDs to each other, which can eliminate the necessity to connect to the server 14, and thus remote meetings to be conducted easier. Furthermore, if communication between HMDs is faster than connecting to the server 14, the motions of avatars can follow the motions of participants more quickly.

### Other Embodiments

In the description above, the video display control device according to the present invention has been applied to a remote meeting system, however, it is not limited thereto.

For example, in a chat using a plurality of avatar images, the participant P1 may select a coastal landscape, the participant P2 may select a mountain landscape, and the participant P3 may select a school as the virtual reality spaces, respectively, so that the avatars A1, A2, A3 of the participants P1, P2, P3 can be displayed simultaneously in the virtual reality spaces selected by the participants, respectively.

In the embodiments described above, the directions in which the avatars A1, A2, A3 are facing are associated with each other, and thus the directions in which the avatar A2 and the avatar A3 are facing relative to the avatar A1 and the directions in which the avatar A2 and the avatar A3 are facing each other are the same in each virtual reality space. However, control of displaying the avatars A1, A2, A3 in different virtual reality spaces simultaneously but not controlling their orientations to be the same may be carried out.

This allows, for example, friends to gather and chat using avatars, each selecting their preferred virtual reality space to enjoy conversation.

Furthermore, unlike the embodiments above, by making the avatars to be displayed common in the virtual reality space but not controlling their orientations, reduction in communication volume and lowering of the processing load of the video display control device can be realized.

Still further, the example of simultaneously displaying multiple avatars across different virtual reality spaces has been described above, however, multiple avatars can be displayed simultaneously across different real world areas, in other words, different virtual reality spaces may be created by simultaneously and commonly displaying multiple avatars.

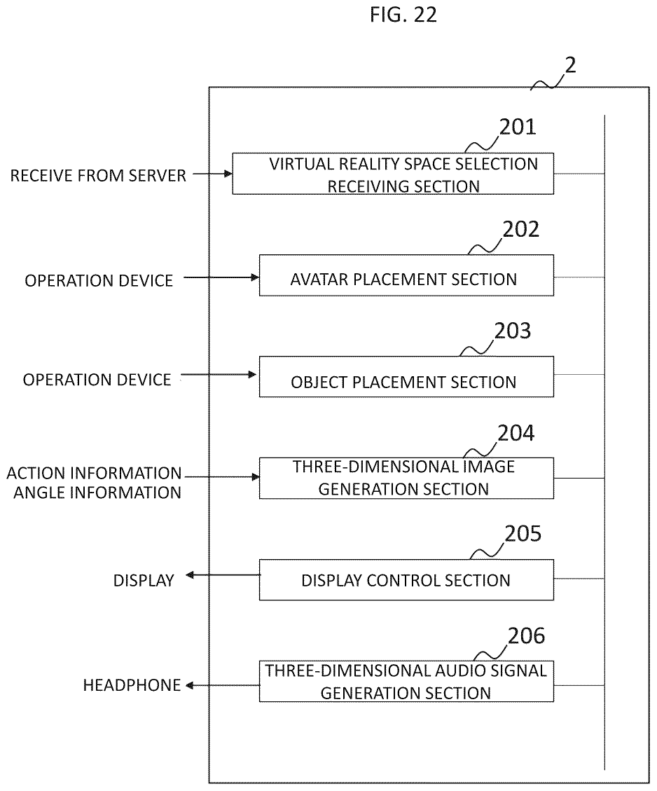

FIG. 22 illustrates an example of a program configuration according to the present embodiment. In each of the HMD G1 to the HMDG 3, a video display program for realizing the video display method according to the present embodiment is stored in the program storage area 41, and the processor 2 loads and executes it in the program function area 43, thereby realizing the functions of a virtual reality space selection receiving section 201, an avatar placement section 202, an object placement section 203, a three-dimensional image generation section 204, a display control section 205, and a three-dimensional audio signal generation section 206.

The virtual reality space selection receiving section 201 displays selectable virtual reality spaces (for example, virtual meeting rooms) received from the server 14, the virtual reality images stored in the HMD G1 to G3 in advance, or a real space video captured by the out-camera 71 on the display 72 so as to accept selection operations from the operation device 9. The avatar is displayed on the virtual reality space or the real space (hereinafter, referred to as a “background”) selected here. In the third embodiment, virtual meeting rooms of others for which copying is permitted are also displayed as selectable options.

The avatar placement section 202 accepts the designation of the display position (own seat) of the user's own avatar, and places other avatars on the background selected above.

The object placement section 203 places the objects based on the operation by the operation device 9, or receives the objects placed by other HMDs received from the server 14 and places them on the background selected above.

The three-dimensional image generation section 204 moves the avatars based on the action information, and generates moving images (video information) of three-dimensional images in which the angle at which the background or objects can be seen is changed based on the angle information.

The display control section 205 displays the video information generated by the three-dimensional image generation section 204 on the display 72.

The three-dimensional audio signal generation section 206 generates a three-dimensional audio signal in accordance with the positional relationship of the avatars. This configuration is necessary in the second embodiment, but is not essential in the first and third embodiments.

In FIG. 22, the virtual reality space selection receiving section 201 to the three-dimensional image generation section 204 are connected to the server to receive information, however, the three-dimensional image generation section 204 may not be connected to the server.

In this case, the generation of three-dimensional images is carried out only by the HMD, which results in reduction in the network load compared to the case where the HMD receives the three-dimensional images generated by the server via the network.

In the above, the embodiments of the present invention have been described, and of course, the configurations for implementing the technical features according to the present invention are not limited to those described in these embodiments and various modifications can be made. For example, the embodiments described above have been explained in detail for the purpose of making the present invention to be understood easily, and thus are not necessarily limited to those having all the configurations as described. Furthermore, a part of the configuration of an embodiment may be replaced with the configuration of a further embodiment, and the configuration of an embodiment may include the configuration of a further embodiment, which are all included in the scope of the present invention. The numerical values and messages appearing in the text and drawings are merely examples, and accordingly, the advantageous effects of the present invention are not impaired even if different ones are used.

Furthermore, the examples have been described in which setting in the system is performed when a participant enters or during his or her stay in the virtual meeting room, however, the present invention is not limited thereto, and default values of the system or preset values set by the participants in advance may be used.

Each of the programs described in the examples of the processing may be an independent program, or a plurality of programs configuring one application program. Still further, the orders of executing the processes may be changed.

Some or all the functions and the like of the present invention may be implemented by hardware, for example, by designing them with integrated circuitry. Still further, a microprocessor unit, a CPU, or the like may interpret and execute an operation program so that some or all the functions and the like of the present invention can be implemented by software. Still further, the implementation range of the software is not limited, and hardware and software may be used in combination. Still further, some or all the functions may be realized by a server. Note that the server may be the one which executes the functions in cooperation with other components by communication, which may be, for example, a local server, a cloud server, an edge server, a net service, or the like. Information such as programs, tables, and files for realizing the functions may be stored in a recording device such as a memory, a hard disk, or an SSD (Solid State Drive), or a recording medium such as an IC card, an SD card, or a DVD, or may be stored in a device on a communication network.

Still further, the control lines and information lines which are considered to be necessary for the purpose of explanation are indicated herein, but not all the control lines and information lines of actual products are necessarily indicated. It may be considered that almost all the components are actually connected to each other.

### (Appendix 1)

A video display system comprising:
a server; and
a plurality of video display devices,
the server and the plurality of video display devices being connected for communication therebetween, respectively,
the server including:
a storage device configured to store participant management information in which avatars corresponding to users of the plurality of video display devices, respectively, is recorded; and
a first communication interface configured to transmit the participant management information to the plurality of video display devices, respectively, and
each of the video display devices including:
a second communication interface configured to receive the participant management information;
an operation device configured to receive selection of a virtual reality space to be displayed on the video display device;
a display; and
a processor configured to refer to the participant management information to generate a video in which avatars corresponding to all other users than a user of the video display device are placed in the virtual reality space selected for the video display device, and carry out display control for the display

### (Appendix 2)

A video display method to be executed by connecting a server and a plurality of video display devices, respectively, for communication, the method comprising:
in the server,
storing participant management information in which avatars corresponding to users of the plurality of video display devices, respectively, are recorded; and
transmitting the participant management information from the server to the plurality of video display devices, respectively; and
in each of the video display devices,
accepting selection of a virtual reality space to be used in the video display device;
receiving the participant management information;
referring to the participant management information to generate a video in which avatars corresponding to all users other than a user of the video display device are placed in the virtual reality space of which selected is accepted by the video display device; and
displaying the video on the display.

### (Appendix 3)

A portable information terminal comprising:
a display;
a processor;
a communication interface; and
a memory,
the memory being configured to store therein participant management information in which an avatar corresponding to a user of the portable information terminal and avatars corresponding to users of other portable information terminals that are connected for communication via the communication interface are recorded, and
the processor being configured to refer to the participant management information to generate a video, in which the avatar corresponding to the user of the portable information terminal and the avatars corresponding to the users of the other portable information terminals are placed, in the virtual reality space selected for the portable information terminal, and execute control of causing the display to display the video.

### REFERENCE SIGNS LIST

1: video display system
2: processor
3: system bus
4: storage device
5: sensor group
6: communication processing device
7: video processing device
8: audio processing device
9: operation device
13: network
14: server
41: program storage area
42: data storage area
43: program function area
51: GPS receiver
52: geomagnetic sensor
53: distance sensor
54: acceleration sensor
55: gyroscope sensor
61: LAN communication I/F
62: telephone network communication I/F
71: out-camera
72: display
81: microphone
82: speaker
83: audio recognition section
84: audio decoding section
142: processor
143: system bus
144: storage device
146: LAN communication I/F
147: display
149: operation device
201: virtual reality space selection receiving section
202: avatar placement section
203: object placement section
204: three-dimensional image generation section
205: display control section
206: three-dimensional audio signal generation section
300: hand
301: virtual meeting room
301t: table
302: virtual meeting room
302t: table
303: virtual meeting room
303t: table
800: participant management table
801: item
802: item
1201: item
1202: item
1401: item
1402: item
1441: program storage area
1442: data storage area
1443: program function area
1900: participant management table
1901: virtual meeting room
1902: virtual meeting room
A1: avatar
A2: avatar
A3: avatar
An: avatar
Ab1: avatar image
Ab2: avatar image
Ab3: avatar image
B0: object
B1: object
B2: object
Bk: object
G1: HMD
G2: HMD
G3: HMD
H1; headphones
H1: output portion
Hr: output portion
LA1: participant number
LA2: participant number
LA3: participant number
LAn: participant number
P1: participant
P2: participant
P3: participant
R1: wireless router
R2: wireless router
R3: wireless router
S1: position
S2: position
S3: position
S4: position
S5: position

1. A video display system comprising:
a server; and
a plurality of video display devices,
the server and the plurality of video display devices being connected for communication therebetween, respectively,
the server including:
a storage device configured to store participant management information in which avatars corresponding to users of the plurality of video display devices, respectively, is recorded; and
a first communication interface configured to transmit the participant management information to the plurality of video display devices, respectively, and
each of the video display devices including:
a second communication interface configured to receive the participant management information;
an operation device configured to receive selection of a virtual reality space to be displayed on the video display device;
a display; and
a processor configured to refer to the participant management information to generate a video in which avatars corresponding to all other users than a user of the video display device are placed in the virtual reality space selected for the video display device, and carry out display control for the display.

2. The video display system according to claim 1, wherein
in each of the video display devices,
the processor is configured to accept designation of positions where the avatars corresponding to all the other users are to be displayed in the virtual reality space selected for the video display device, generate a video in which the avatars corresponding to all the other users are placed at the positions designated in the virtual reality space, and carry out display control.

3. The video display system according to claim 2, wherein
the participant management information records therein one of a body, a face, or a line of sight of each of the avatars as an orientation of the avatar,
the orientation of the avatar is defined using a display position of another avatar, and
in each of the video display devices, the processor is configured to generate a video in which each of the avatars is facing the other avatar defined in the participant management information in the virtual reality space selected by the video display device, and carry out display control.

4. The video display system according to claim 3, wherein
in each of the video display devices,
the operation device accepts input of content including at least one of an object, data, or a whiteboard to be displayed in the virtual reality space selected by the video display device,
the processor is configured to generate a video in which the content is displayed in the virtual reality space selected by the video display device and carry out display control of the video, and also carry out transmission control of transmitting the content to the server via the second communication interface,
the server updates the content and records the content as updated in the participant management information, and transmits the participant management information as updated to all the video display devices, and
among the video display devices, in each of other video display devices than a video display device that has accepted display of the content,
the processor is configured to place the content recorded in the participant management information as updated in the virtual reality space selected by each of the other video display devices.

5. The video display system according to claim 1, wherein
each of the video display devices is a head-mounted display to be worn on a head of each user,
the head-mounted display includes at least one of a gyroscope sensor or an acceleration sensor, and
the processor is configured to detect a change in a position of an avatar corresponding to each of the users or an orientation thereof based on angle information obtained from the gyroscope sensor or the acceleration sensor, generate the video, and carry out display control of the video as generated.

6. The video display system according to claim 1, wherein
the processor is configured to generate a three-dimensional audio signal based on a positional relationship of a plurality of avatars being displayed on the video display device, and transmit the three-dimensional audio signal to stereo headphones linked to the video display device.

7. The video display system according to claim 1, wherein
in the participant management information, duplication permission information for permitting another video display device to duplicate information about the virtual reality space, of which selection has been accepted by the video display device, is defined,
the server transmits the virtual reality space for which duplication is permitted to another video display device that is different from the video display device that has accepted the selection of the virtual reality space, and,
in the other video display device, the processor is configured to display, on the display, the virtual reality space for which duplication is permitted and which has been selected by the other video display device,
the operation device accepts input of an instruction to use, as the virtual reality space for the video display device, one of virtual reality spaces being displayed on the display, which has been selected in the other video display device, and
the processor is configured to generate a video in which the virtual reality space instructed for use by the operation device is used as the virtual reality space for the video display device, and carry out display control of the video as generated.

8. A video display method to be executed by connecting a server and a plurality of video display devices, respectively, for communication, the method comprising:
in the server, storing participant management information in which avatars corresponding to users of the plurality of video display devices, respectively, are recorded; and
transmitting the participant management information from the server to the plurality of video display devices, respectively; and
in each of the video display devices,
accepting selection of a virtual reality space to be used in the video display device;
receiving the participant management information;
referring to the participant management information to generate a video in which avatars corresponding to all users other than a user of the video display device are placed in the virtual reality space of which selected is accepted by the video display device; and
displaying the video on the display.

9. A portable information terminal comprising:
a display;
a processor;
a communication interface; and
a memory,
the memory being configured to store therein participant management information in which an avatar corresponding to a user of the portable information terminal and avatars corresponding to users of other portable information terminals that are connected for communication via the communication interface are recorded, and
the processor being configured to refer to the participant management information to generate a video, in which the avatar corresponding to the user of the portable information terminal and the avatars corresponding to the users of the other portable information terminals are placed, in the virtual reality space selected for the portable information terminal, and execute control of causing the display to display the video.
